(19) United States
(12) Patent Application Publication
(10) Pub. No.: US 2008/0308018 A1
(43) Pub. Date: Dec. 18, 2008

(54) Apparatus for Producing Refuse-Derived Solid Fuel Using Combustible Waste

(76) Inventor: Song-Kwon Kang, Gyeonggi-do (KR)

Correspondence Address: CANTOR COLBURN, LLP, 20 Church Street, 22nd Floor, Hartford, CT, 06103, US

(21) Appl. No.: 11/574,268

(22) PCT Filed: Aug. 24, 2005
(86) PCT No.: PCT/KR05/02787

§ 371 Date: Feb. 26, 2007

(30) Foreign Application Priority Data
Aug. 26, 2004 (KR) 10-2004-0067503

(51) Int. Cl. F23G 5/04; C10L 5/46; B01D 1/04

(52) U.S. Cl. 110/223; 110/224; 110/227; 110/228; 44/597

(57) ABSTRACT

Disclosed herein is an apparatus for producing a refuse-derived solid fuel using combustible waste. The apparatus of the present invention includes a forming body (10) which has a hopper (10a) through which combustible waste is supplied into the forming body (10), with a drive unit (11) mounted to the forming body (10). The apparatus further includes a force-feed pipe (30) which is mounted to the forming body (10). Thermal oil flows through a space defined between layers constituting the force-feed pipe (30). A force-feed screw (50) is provided in the force-feed pipe (30). The apparatus further includes a siphon (70) which is provided in a space defined in the force-feed screw, so that thermal oil flows through the siphon (70), thus drying the combustible waste. The apparatus further includes a plurality of rod type heaters (90) which are disposed at the first end of the force-feed pipe (30), thus heating an outer surface of the compressed waste.

### TECHNICAL FIELD

The present invention relates, in general, to apparatuses for producing refuse-derived solid fuel and more particularly, to an apparatus for producing a refuse-derived solid fuel using combustible waste, in which water in the refuse-derived solid fuel is removed to a level that satisfies a reference value, thus making it possible for the refuse-derived solid fuel to be safely and easily used.

### BACKGROUND ART

Generally, waste is classified into industrial waste and general waste. 80% or more of such waste is able to be burned. However, most waste is scrapped without being burned thereby environmental pollution results.

To solve the above-mentioned problem, a method in which combustible waste is reused as a fuel having superior heating value has been proposed. The conventional refuse-derived fuel producing method can solve a problem of waste treatment that is increasing in importance as one of recent society's serious problems.

In this refuse-derived fuel production method waste is sorted into incombustible waste and combustible waste. Thereafter, the combustible waste is cut and crushed while passing through first through fourth stages. Subsequently, the combustible waste is dried in drying rooms. In a final stage, comburent, serving as a neutralizer, is sprayed on the combustible waste, thus removing gas and odor from the waste. As a result, a refuse-derived fuel is produced.

However, the conventional refuse-derived fuel production method has the following disadvantages.

Only when the water content of a product, which is produced by cutting and crushing combustible waste through the first through fourth stages and by drying it, satisfies a reference value (from 7% to 8%) can the product serve as a fuel and become hard. However, in the conventional refuse-derived fuel production method because water is not sufficiently removed from combustible waste during the drying process, the water content in the produced solid fuel is higher than the reference value. Thus, the produced refuse-derived solid fuel is not easily burned. Moreover, there is a problem in that, when the refuse-derived solid fuel is burned a large amount of dioxin is discharged.

Furthermore, in a conventional refuse-derived solid fuel production apparatus, because a heater for drying combustible waste is wound around a force-feed pipe in a coil shape, partial replacement is impossible. Accordingly, there is a problem in that, when some problem in the heater occurs, an entire element must be replaced with another.

### DISCLOSURE OF INVENTION

### Technical Problem

Accordingly, the present invention has been made keeping in mind the above problems occurring in the prior art, and an object of the present invention is to provide an apparatus for producing a refuse-derived solid fuel using combustible waste in which water in the refuse-derived solid fuel is removed to a level that satisfies a reference value, thus making it possible for the refuse-derived solid fuel to be safely and easily used.

### Technical Solution

In order to accomplish the above objects, the present invention provides an apparatus for producing a refuse-derived solid fuel by pressing and drying combustible waste, the apparatus including: a forming body comprising a hopper through which the combustible waste is supplied into the forming body, with a drive unit mounted to the forming body at a predetermined position; a force-feed pipe mounted at a pre-determined position to the forming body and comprising a cylindrical double pipe having a circular cross-section, with a space defined between layers constituting the cylindrical double pipe so that thermal oil flows in the space, an oil feed pipe provided on a first end of the force-feed pipe so that the thermal oil is fed into the space through the oil feed pipe, and an oil discharge pipe provided on a second end of the force-feed pipe so that the thermal oil is discharged through the oil discharge pipe, thus heating the compressed waste, fed in a predetermined direction by rotation of a force-feed screw, thereby evaporating water contained in the compressed waste; a siphon provided in a space defined in the force-feed screw, rotated by a drive force of the drive unit provided on the forming body, so that thermal oil is supplied from an oil feed unit into the siphon so as to heat the force-feed screw, thus drying the compressed waste force-fed in a predetermined direction through the force-feed pipe, thereby evaporating water contained in the compressed waste; and a plurality of rod type heaters provided at the first end of the force-feed pipe and heating an outer surface of the compressed waste fed from the force-feed pipe, thus smoothing the outer surface of the compressed waste.

### ADVANTAGEOUS EFFECTS

The present invention has the following advantages.

First, in the present invention, combustible waste, which passes through a force-feed pipe, is dried by thermal oil which circulates in a space defined between the layers constituting the force-feed pipe, and the interior of the combustible waste is dried by thermal oil which circulated by a force-feed screw. Thus, the combustible waste is appropriately dried such that the water content in the combustible waste is within a range satisfying a reference value (from 7% to 8%).

Second because the present invention dries the combustible waste such that the water content in the combustible waste is within a range satisfying a reference value, a product, which is a refuse-derived solid fuel, is not fragile. As well, when the refuse-derived solid fuel is burned the amount of dioxin discharged is minimized.

Third, because heaters, which are mounted to the force-feed pipe, have rod shapes, when some problem in the heaters occurs, partial replacement of the heaters is possible.

### BRIEF DESCRIPTION OF THE DRAWINGS

FIG. 1 is a schematic view showing a flow diagram of a process for producing a refuse-derived solid fuel, according to the present invention;

FIG. 2 is a sectional view of an apparatus for producing a refuse-derived solid fuel, according to an embodiment of the present invention;

FIG. 3 is an exploded perspective view showing an important part of the refuse-derived solid fuel producing apparatus of FIG. 2;

FIG. 4 is a perspective view showing an enlargement of circled portion F of FIG. 2;

FIG. 5 is a view showing the circulation of thermal oil that flows through a thermal oil circulation pipeline connected to elements constituting the refuse-derived solid fuel producing apparatus of FIG. 2;

FIG. 6 is a sectional view of an apparatus for producing a refuse-derived solid fuel, according to another embodiment of the present invention;

FIG. 7 is an exploded perspective view showing an important part of the refuse-derived solid fuel production apparatus of FIG. 6;

FIG. 8 is a view showing the circulation of thermal oil that flows through a thermal oil circulation pipeline connected to elements constituting the refuse-derived solid fuel production apparatus of FIG. 6; and

FIG. 9 is a perspective view showing a product produced using the refuse-derived solid fuel producing apparatus according to the present invention.

### BEST MODE FOR CARRYING OUT THE INVENTION

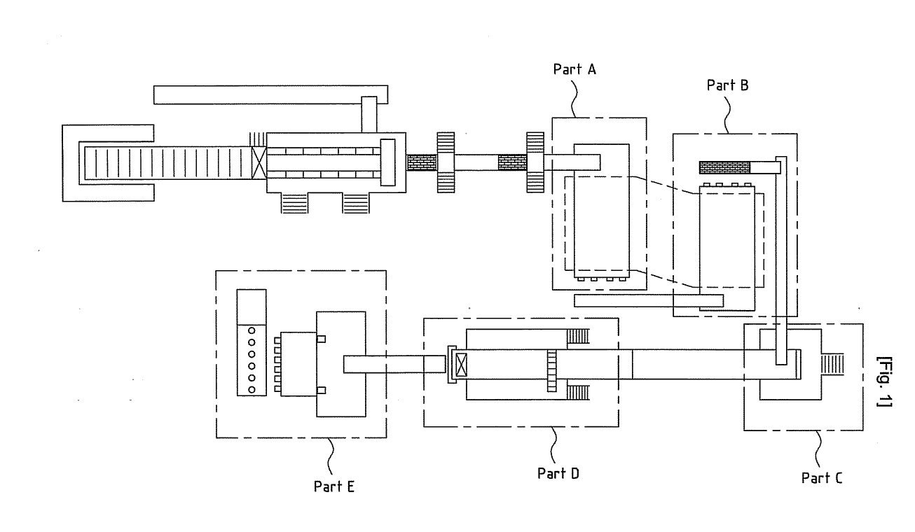

Hereinafter, preferred embodiments of the present invention will be described in detail with reference to FIGS. 1 through 9.

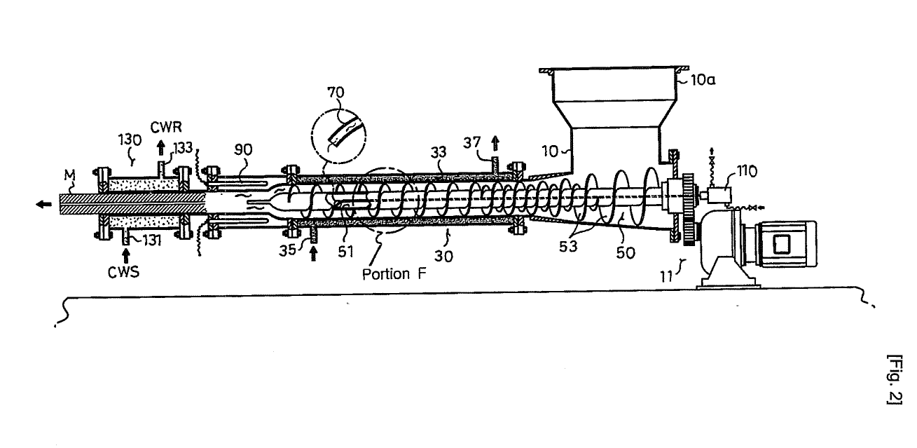

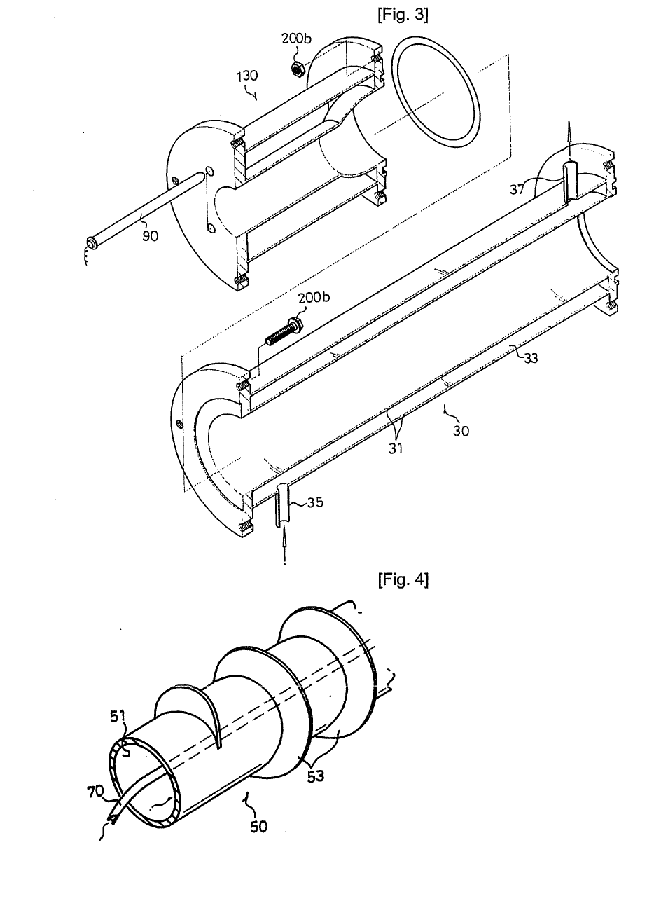

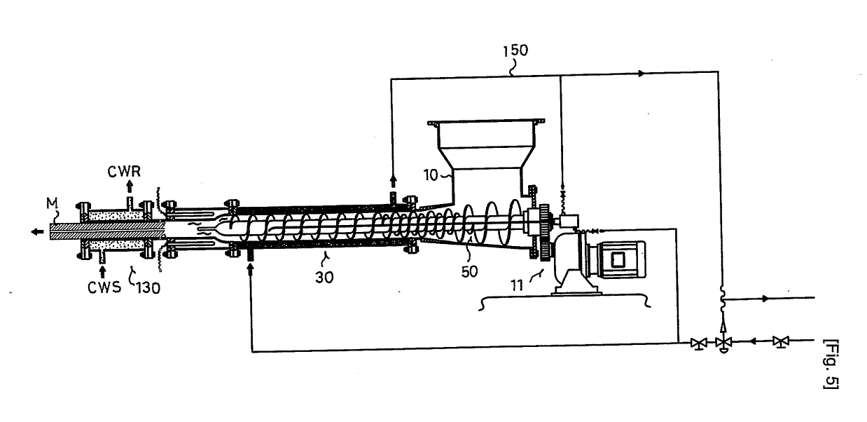

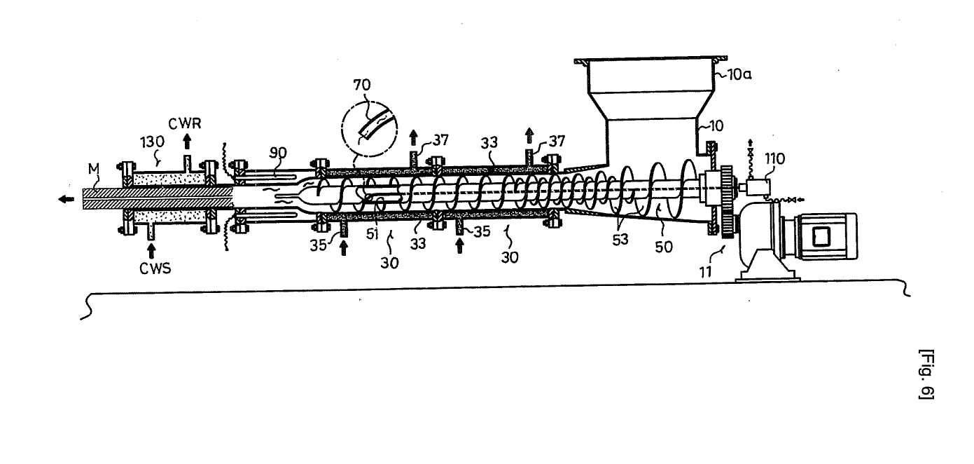

FIG. 1 is a view showing a flow line of a process for producing a refuse-derived solid fuel, according to the present invention. FIG. 2 is a sectional view of an apparatus for producing a refuse-derived solid fuel, according to an embodiment of the present invention. FIG. 3 is an exploded perspective view showing an important part of the refuse-derived solid fuel producing apparatus of FIG. 2. FIG. 4 is a perspective view showing an enlargement of a circled portion F of FIG. 2. FIG. 5 is a view showing the circulation of thermal oil that flows along a thermal oil circulation pipeline connected to elements constituting the refuse-derived solid fuel producing apparatus of FIG. 2.

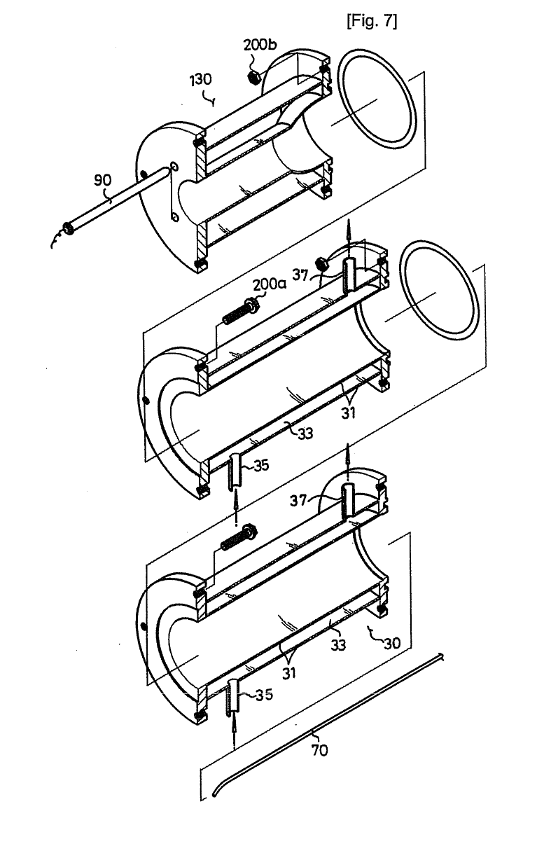

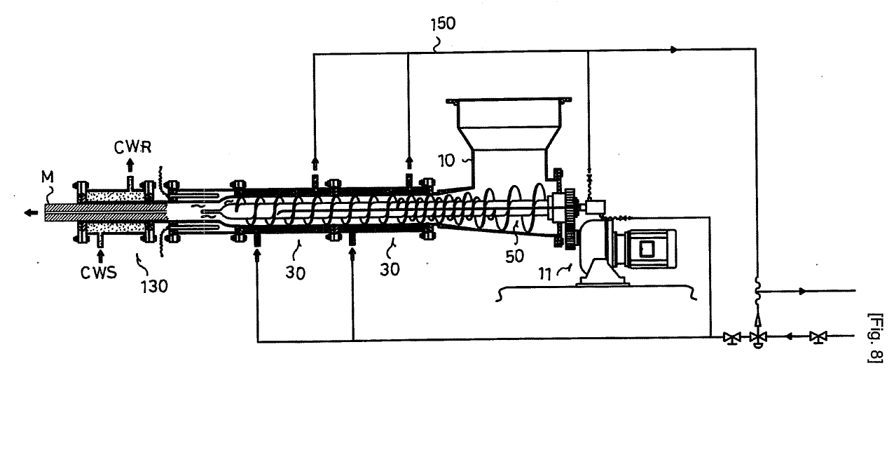

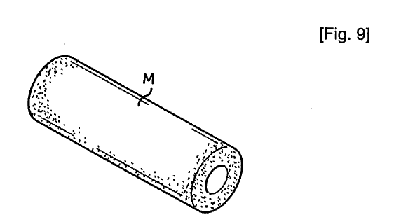

FIG. 6 is a sectional view of an apparatus for producing a refuse-derived solid fuel, according to another embodiment of the present invention. FIG. 7 is an exploded perspective view showing an important part of the refuse-derived solid fuel producing apparatus of FIG. 6. FIG. 8 is a view showing the circulation of thermal oil that flows along a thermal oil circulation pipeline connected to elements constituting the refuse-derived solid fuel production apparatus of FIG. 6. FIG. 9 is a perspective view showing a product produced by the refuse-derived solid fuel production apparatus according to the present invention.

Referring to the drawings, the refuse-derived solid fuel production apparatus of the present invention includes a forming body 10 which has a hopper 10a, through which combustible waste is supplied into the forming body 10. A drive unit 11 is mounted to the forming body 10 at a predetermined position. The refuse-derived solid fuel producing apparatus further includes a force-feed pipe 30 which is mounted at a pre-determined position to the forming body 10 and comprises a cylindrical double pipe 31 having a circular cross-section. A space 33 is defined between layers constituting the cylindrical double pipe 31 so that thermal oil flows in the space 33. An oil feed pipe 35 is provided on a first end of the force-feed pipe 30 so that the thermal oil is fed into the space 33 through the oil feed pipe 35. An oil discharge pipe 37 is provided on a second end of the force-feed pipe 30 so that the thermal oil is discharged through the oil discharge pipe 37. Thus, the force-feed pipe 30 heats the compressed waste, which is fed in a predetermined direction by the rotation of a force-feed screw 50, thereby evaporating water contained in the compressed waste. The refuse-derived solid fuel producing apparatus further includes a siphon 70 which is provided in a space 51 defined in the force-feed screw 50, which is rotated by the drive force of the drive unit 11 mounted to the forming body 10, so that thermal oil is supplied from an oil feed unit into the siphon 70 to heat the force-feed screw 50, thus heating the compressed waste, which is fed in a predetermined direction through the force-feed pipe 30, thereby evaporating water contained in the compressed waste. The refuse-derived solid fuel producing apparatus further includes a plurality of rod type heaters 90, which are provided at the first end of the force-feed pipe 30 and heats an outer surface of the compressed waste fed from the force-feed pipe 30 to smooth the outer surface of the compressed waste.

Here, the oil feed unit, which supplies thermal oil at high temperature into the siphon 70 provided in the force-feed screw 50, comprises a rotary joint 110.

The thermal oil to be supplied into both the force-feed pipe 30 and the force-feed screw 50 has a temperature ranging from 250° C. to 300° C. such that the water content of the waste is from 7% to 8%.

Meanwhile, the force-feed pipe 30 may comprise two force-feed pipes 30 which have the same structure and are removably coupled to each other by a locking member including a locking bolt 200a and a locking nut 200b.

The operation of the present invention will be explained herein below.

As shown in FIG. 1, in a process of sorting waste into incombustible waste and combustible waste, the combustible waste is cut and crushed in first through fourth stages. Furthermore, while the combustible waste passes through a plurality of drying rooms, water is removed from the combustible waste. Here, water in the combustible waste is first-removed in part A. Water in the combustible waste is second-removed in part B. Water in the combustible waste is third-removed in part C. Water in the combustible waste is fourth-removed in part D.

The combustible waste, having passed from part A to part D, is dried in part E such that its water content becomes from 7% to 8%. Then, a final product (M), which is a refuse-derived solid fuel, is produced as shown in FIG. 9.

To achieve the above-mentioned purpose such that the water content in the combustible waste becomes from 7% to 8%, the present invention is provided in part E. In the present invention, when combustible waste is supplied through the hopper 10a, the force-feed screw 50, an end of which engages with a gear of the output shaft of the motor which is the drive unit 11 mounted to the forming body 10, is rotated by the drive force transmitted from the motor. Then, a rotary blade 53 of the force-feed screw 50 rotates along with the force-feed screw 50. As a result, combustible waste is compressed and discharged outside through the force-feed pipe 30.

As such, while the combustible waste is discharged outside through the force-feed pipe 30, thermal oil at high temperature is supplied from the rotary joint 110, which is the oil feed unit, into the siphon 70 provided in the space 51 in the force-feed screw 50. The thermal oil, having passed through the siphon 70, is again returned to the rotary joint 110 through the space 51 of the force-feed screw 50. Due to the circulation of the thermal oil, the force-feed screw 50 maintains a temperature ranging from 250° C. to 300° C., thus drying the combustible waste.

Meanwhile, thermal oil is supplied through the oil feed pipe 35 into the space 33 in the layers constituting the force-feed pipe 30, through which the combustible waste is passed by the rotation of the force-feed screw 50 in a predetermined direction. The thermal oil, supplied into the space 33, is discharged through the oil discharge pipe 37, and it continuously circulates, so that the force-feed pipe 30 maintains a temperature ranging from 250° C. to 300° C., thus drying the combustible waste.

In other words, as shown in FIG. 5, the thermal oil circulation pipeline 150 couples all connection parts, which are provided on both the force-feed screw 50 and the force-feed pipe 30, together. The thermal oil circulates the thermal oil circulation pipeline 150 under the control of a separate controller, such that the water content in the combustible waste ranges from 7% to 8%.

Furthermore, the plurality of rod type heaters 90, which are mounted to the first end of the force-feed pipe 30, heats the compressed combustible waste that is to be discharged from the force-feed pipe 30, thus smoothing the outer surface of the compressed combustible waste such that the combustible waste can be easily discharged from the force-feed pipe 30. In the present invention, when some problem in the heaters 90 occurs, partial replacement of the heaters 90 is possible.

Meanwhile, a cooling unit 130 is disposed at ends of the heaters 90. A water feed pipe 131 and a water discharge pipe 133 are coupled to the cooling unit 130, so that cooling water circulates through the cooling unit 130 via the water feed pipe 131 and the water discharge pipe 133. Thus, a final product (M), which is produced at high temperature, is cooled by the cooling water.

In the present invention, as shown in another embodiment of FIGS. 6 and 7, the force-feed pipe 30 may comprise two force-feed pipes 30 which have the same structure and are removably coupled to each other by the locking member.

In this case, as shown in FIG. 8, a thermal oil circulation pipeline 150 is coupled to oil feed pipes and oil discharge pipes of the two force-feed pipes 30, which are removably coupled to each other. Thus, thermal oil circulates through the thermal oil circulation pipeline 150 under the control of a separate controller. Thereby, the combustible waste is dried until the water content in the combustible waste is within a range satisfying a reference value.

Although the preferred embodiments of the present invention have been disclosed for illustrative purposes, the refuse-derived solid fuel producing apparatus of the present invention is not limited to the above-mentioned structure, and those skilled in the art will appreciate that various modifications, additions and substitutions are possible, without departing from the scope and spirit of the invention as disclosed in the accompanying claims.

### INDUSTRIAL APPLICABILITY

As describe above, the present invention has the following advantages.

First, in the present invention, combustible waste, which passes through a force-feed pipe, is dried by thermal oil which circulates in a space defined between the layers constituting the force-feed pipe, and the interior of the combustible waste is dried by thermal oil which circulated by a force-feed screw. Thus, the combustible waste is appropriately dried such that the water content in the combustible waste is within a range satisfying a reference value (from 7% to 8%).

Second, because the present invention dries the combustible waste such that the water content in the combustible waste is within a range satisfying a reference value, a product, which is a refuse-derived solid fuel, is not fragile. As well, when the refuse-derived solid fuel is burned the amount of dioxin discharged is minimized.

Third, because heaters, which are mounted to the force-feed pipe, have rod shapes, when some problem in the heaters occurs, partial replacement of the heaters is possible.

1. An apparatus for producing a refuse-derived solid fuel by pressing and drying combustible waste, the apparatus comprising:
a forming body comprising a hopper through which the combustible waste is supplied into the forming body, with a drive unit mounted to the forming body at a predetermined position;
a force-feed pipe mounted at a predetermined position to the forming body and comprising a cylindrical double pipe having a circular cross-section, with a space defined between layers constituting the cylindrical double pipe so that thermal oil flows in the space, an oil feed pipe provided on a first end of the force-feed pipe so that the thermal oil is fed into the space through the oil feed pipe, and an oil discharge pipe provided on a second end of the force-feed pipe so that the thermal oil is discharged through the oil discharge pipe, thus heating the compressed waste, fed in a predetermined direction by rotation of a force-feed screw, thereby evaporating water contained in the compressed waste;
a siphon provided in a space defined in the force-feed screw, rotated by a drive force of the drive unit provided on the forming body, so that thermal oil is supplied from an oil feed unit into the siphon so as to heat the force-feed screw, thus drying the compressed waste force-fed in a predetermined direction through the force-feed pipe, thereby evaporating water contained in the compressed waste; and
a plurality of rod type heaters provided at the first end of the force-feed pipe and heating an outer surface of the compressed waste fed from the force-feed pipe, thus smoothing the outer surface of the compressed waste.

2. The refuse-derived solid fuel producing apparatus according to claim 1, wherein the oil feed unit, which supplies the thermal oil into the siphon provided in the force-feed screw, comprises a rotary joint.

3. The refuse-derived solid fuel producing apparatus according to claim 1, wherein the thermal oil to be supplied into both the force-feed pipe and the force-feed screw has a temperature ranging from 250° C. to 300° C. such that a water content in the waste is from 7% to 8%.

4. The refuse-derived solid fuel producing apparatus according to claim 1, wherein the force-feed pipe comprises two force-feed pipes which have identical structure and are removably coupled to each other by a locking member.
